(19) United States
(12) Patent Application Publication
(10) Pub. No.: US 2013/0335820 A1
(43) Pub. Date: Dec. 19, 2013

(54) ILLUMINATING UNIT AND INVERTED MICROSCOPE

(71) Applicant: OLYMPUS CORPORATION, Tokyo (JP)

(72) Inventors: Yusuke MATSUMOTO, Tokyo (JP); Akihiro KITAHARA, Tokyo (JP)

(21) Appl. No.: 13/904,959

(22) Filed: May 29, 2013

(30) Foreign Application Priority Data
Jun. 15, 2012 (JP) 2012-136244

(51) Int. Cl. G02B 21/08

(52) U.S. Cl. CPC G02B 21/086
USPC 359/390; 359/385

(57) ABSTRACT

An illuminating unit that is a part of a microscope for forming an image of a specimen being an observation object, that is located above a stage on which the specimen is placed, and that applies transmitting illumination light to the specimen includes a light source unit including a light source that generates the transmitting illumination light, and a condenser unit that includes a condenser lens for collecting and applying the transmitting illumination light emitted by the light source unit onto the specimen, and that is detachably connected to the light source unit.

### CROSS-REFERENCE TO RELATED APPLICATIONS

This application is based upon and claims the benefit of priority from Japanese Patent Application No. 2012-136244, filed on Jun. 15, 2012, the entire contents of which are incorporated herein by reference.

### BACKGROUND OF THE INVENTION

1. Field of the Invention

The present invention relates to an illuminating unit that applies transmitting illumination to a microscope that forms an image of a specimen as an observation object, and an inverted microscope including the illuminating unit.

2. Description of the Related Art

Conventionally, as an inverted microscope for observing a specimen placed on a stage from below the stage, there is a known inverted microscope disclosed in, for example, Japanese Laid-open Patent Publication No. 2004-109919, in which a transmitting-illumination light source is disposed above the stage and a condenser lens is disposed in an optical path of the light source between the light source and the stage. In such an inverted microscope, the light source and the condenser lens are fixed, so that it is difficult to adjust them according to specimens with various thicknesses and it is therefore difficult to improve the scalability of the system. In addition, there is a problem in that the work efficiency is lowered because the condenser lens becomes a structural obstacle when a specimen is replaced or a manipulator is set.

As a technology for solving the above problems, as disclosed in Japanese Laid-open Patent Publication No. 17939 for example, there is a known inverted microscope including a condenser holder that detachably holds the condenser lens such that the condenser lens can rotate in a direction in which the condenser lens is deviated from the optical path of the transmitting illumination light.

### SUMMARY OF THE INVENTION

According to one aspect of the present invention, there is provided an illuminating unit that is a part of a microscope for forming an image of a specimen being an observation object, that is located above a stage on which the specimen is placed, and that applies transmitting illumination light to the specimen, the illuminating unit including: a light source unit including a light source that generates the transmitting illumination light; and a condenser unit that includes a condenser lens for collecting and applying the transmitting illumination light emitted by the light source unit onto the specimen, a that is detachably connected to the light source unit.

According to another aspect of the present invention, there is provided an inverted microscope including: an illuminating unit that is a part of the inverted microscope for forming an image of a specimen being an observation object, that is located above a stage on which the specimen is placed, and that applies transmitting illumination light to the specimen, the illuminating unit including: a light source unit including a light source that generates the transmitting illumination light; and a condenser unit that includes a condenser lens for collecting and applying the transmitting illumination light emitted by the light source unit onto the specimen, and that is detachably connected to the light source unit; and a unit holder that detachably holds the illuminating unit and that is movable up and down relative to the specimen.

According to still another aspect of the present invention, there is provided an inverted microscope including: an illuminating unit that is a part of the inverted microscope for forming an image of a specimen being an observation object, that is located above a stage on which the specimen is placed, and that applies transmitting illumination light to the specimen, the illuminating unit including: a light source unit including a light source that generates the transmitting illumination light; a condenser unit that includes a condenser lens for collecting and applying the transmitting illumination light emitted by the light source unit onto the specimen, and that is detachably connected to the light source unit; and a field stop unit that is located between the light source unit and the condenser unit so as to be detachably connected to the light source unit and the condenser unit, and that includes a field stop; and a unit holder that is movable up and down relative to the specimen and that detachably holds the field stop unit.

The above and other features, advantages and technical and industrial significance of this invention will be better understood by reading the following detailed description of presently preferred embodiments the invention, when considered in connection with the accompanying drawings.

### BRIEF DESCRIPTION OF THE DRAWINGS

FIG. 1 is a diagram schematically illustrating an overall configuration of an inverted microscope according to a first embodiment of the present invention;

FIG. 2 is a diagram schematically illustrating a configuration of an illuminating unit according to the first embodiment of the present invention;

FIG. 3 is a diagram illustrating configurations of the illuminating unit and a unit holder according to the first embodiment of the present invention and an overview of how the illuminating unit is assembled to the unit holder;

FIG. 4 is a top view illustrating the configuration of the unit holder of the inverted microscope according to the first embodiment of the present invention;

FIG. 5 is a diagram illustrating configurations of an illuminating unit and a unit holder according to a second embodiment of the present invention and an overview of now the illuminating unit is assembled to the unit holder; and

FIG. 6 is a diagram illustrating configurations of an illuminating unit and a unit holder according to a third embodiment of the present invention and an overview of how the illuminating unit is assembled to the unit holder.

### DETAILED DESCRIPTION OF THE PREFERRED EMBODIMENTS

Exemplary embodiments (hereinafter, “embodiments”) of the present invention will be explained below with reference to the accompanying drawings. The drawings referred in the below description are schematic, and when the same object is illustrated in different drawings, the dimensions, the scale, and the like may differ.

### First Embodiment

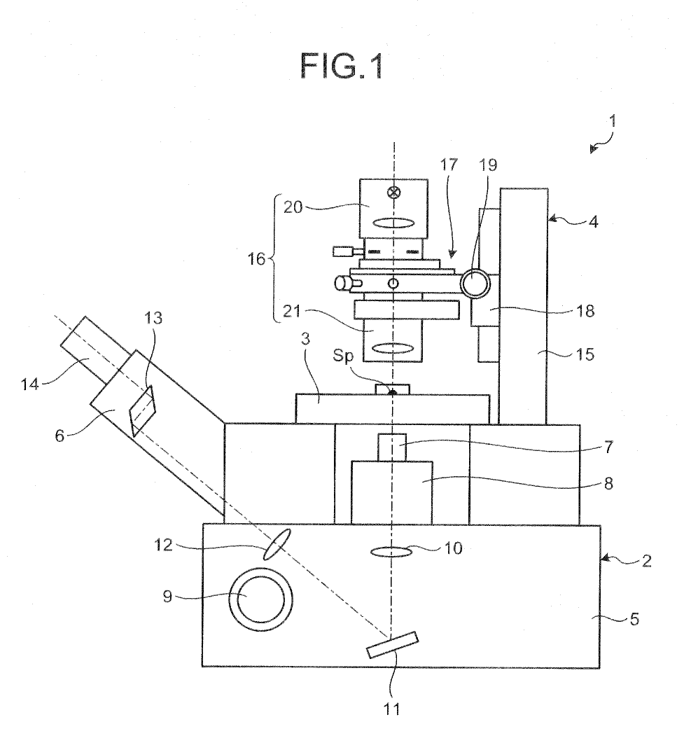

FIG. 1 is a diagram schematically illustrating an overall configuration of an inverted microscope according to a first embodiment of the present invention. An inverted microscope 1 illustrated in FIG. 1 includes a main body 2 serving as a base, a stage 3 that is mounted on a top surface of the main body 2 and that is used for placing a specimen Sp, and a transmitting illumination unit 4 that is located above the main body 2 and that applies transmitting illumination to the specimen Sp placed on the stage 3. The specimen Sp is held by a dish, a microscope slide, a beaker, or the like.

The main body 2 includes a casing 5 that supports the stage 3 and the transmitting illumination unit 4, and a lens barrel 6 that is provided on a front surface (left side surface in FIG. 1) that is a side surface facing a user of the inverted microscope 1 among the side surfaces of the casing 5.

The casing 5 includes a holder board 8 that holds an objective lens 7 in a replaceable manner, a focusing operating unit 9 that enables manual or electric focusing operation for adjusting the focal position of the objective lens 7 to the specimen Sp by moving the holder board 8 up and down, a tube lens 10 that focuses observation light of the specimen Sp incident through the objective lens 7 that has an optical axis passing through the specimen Sp, mirror 11 that reflects the observation light focused by the tube lens 10, and a relay lens 12 that relays the observation light reflected by the mirror 11.

The lens barrel 6 includes a prism 13 that changes the optical path of the light that has passed through the relay lens 12, and an eyepiece 14 that collects the light, the optical path of which has been changed by the prism 13.

A configuration of the transmitting illumination unit 4 will be explained below. The transmitting illumination unit 4 includes a transmitting illumination support 15 that is mounted on the main body 2 and that extends upward, an illuminating unit 16 that generates transmitting illumination light and focuses the transmitting illumination light onto the specimen Sp, a unit holder 17 that is mounted on the transmitting illumination support 15 and that detachably holds the illuminating unit 16, a moving unit 18 that moves the unit holder 17 up and down, and an operating unit 19 that operates the moving unit 18. The moving unit 18 is formed of, for example, a rack and a pinion. In this case, the axis of the pinion matches the rotation axis of the operating unit 19.

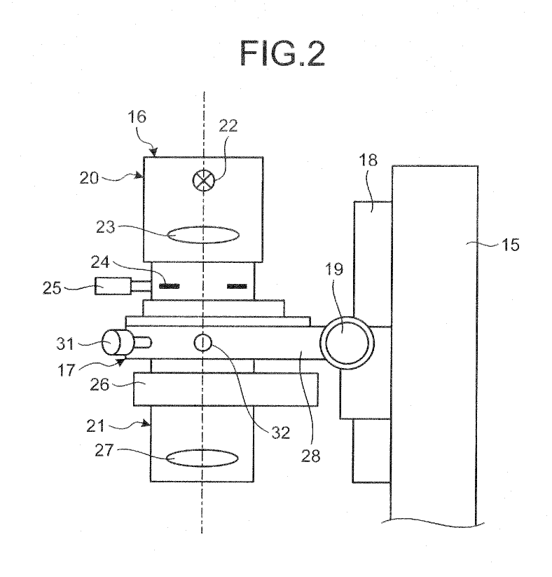

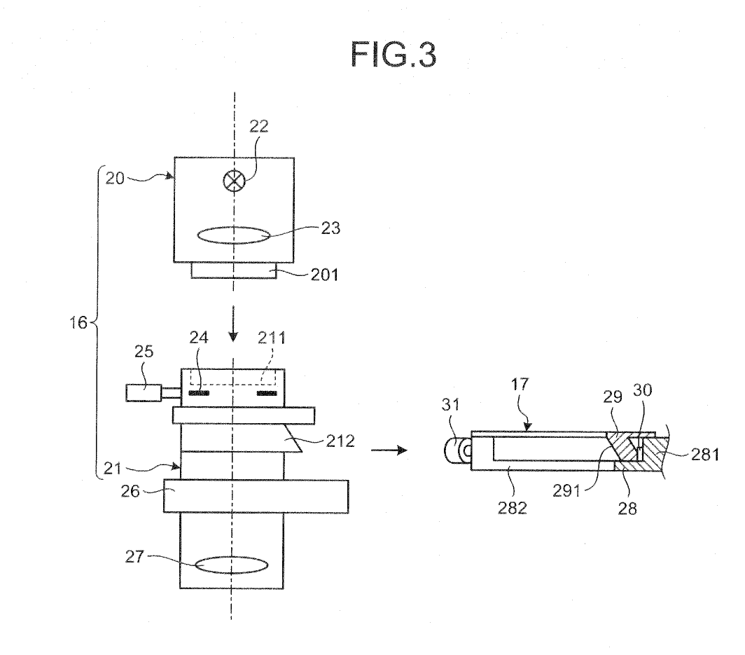

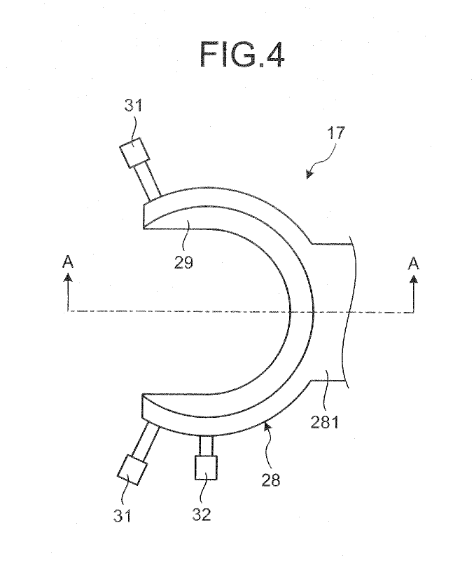

FIG. 2 is a diagram illustrating a configuration of the illuminating unit 16. FIG. 3 is a diagram illustrating configurations of the illuminating unit 16 and the unit holder 17 and an overview of how the illuminating unit 16 is assembled to the unit holder 17. FIG. 4 is a top view illustrating the configuration of the unit holder 17. The unit holder 17 illustrated in FIG. 3 corresponds to a cross-section taken along line A-A in FIG. 4. The configurations of the illuminating unit 16 and the unit holder 17 will be explained below with reference to FIG. 2 to FIG. 4.

First, the configuration of the illuminating unit 16 will be explained. The illuminating unit 16 includes a light source unit 20 that generates and emits transmitting illumination light, and a condenser unit 21 that is detachably connected to the light source unit 20 and that collects and focuses the transmitting illumination light emitted by the light source unit 20 onto the specimen Sp. The light source unit. 20 and the condenser unit 21 are fixed to each other by a fixing screw (not shown).

The light source unit 20 includes a light source 22 and a collector lens As illustrated in FIG. 3, a convex part 201 to be fitted to the condenser unit 21 is formed on a lower end portion of the light source unit 20. The light source 22 is, for example, a light emitting diode (LED).

The condenser unit 21 includes a field stop 24 that can ad lust an illumination area of the transmitting illumination light emitted by the light source unit 20, a field-stop operating unit 25 that changes a diameter of the field stop 24, an optical element turret 26 that is disposed below the field stop 24 and that holds a plurality of optical elements in a switchable manner, and a condenser lens 27 that collects the transmitting illumination light that has passed through the optical element turret 26 and that uniformly applies the transmitting illumination light to an area including the specimen Sp. The optical element turret 26 is positioned so that an optical element that passes through the optical path of the transmitting illumination light is located t a conjugate position with respect to the eve of the condenser lens 27.

A concave part 211 that is to be fitted to and holds the convex part 201 of the light, source unit 20 is formed on an upper end portion of the condenser unit 21. A male dovetail 212 in a shape that can be fitted to the unit holder 17 is formed, on a lower side surface of the field stop 24 of the condenser unit 21.

The positions of the light source unit 20 and the condenser unit 21 in the optical axis direction of the illuminating unit 16 are determined by fitting the convex part 201 and the concave part 211 and by bringing predetermined contact surfaces of the light source unit 20 and the condenser unit 21 into contact with each other.

The configuration of the unit holder 17 will be explained below. The unit holder 17 includes a holder main body 28 connected to the moving unit 18; a U-shaped member 29, which is fixed to the holder main body 28, which is formed in a U-shape, and in which a female dovetail 291 to be fitted to the male dovetail 212 of the condenser unit 21 is formed on the inner periphery of the U-shape; a plate spring 30 that is mounted on the holder main body 28 to bias the U-shaped member 29 in a direction away from the transmitting illumination support 15; a pair of centering screws 31, which are screwed to the holder main body 28 and which press the U-shaped member 29 against the biasing force of the plate spring 30 so as to adjust the position of the U-shaped member 29 relative to the holder main body 28 for centering; and a side set screw 32 that is screwed the holder main body 28 and used to fix the unit holder 17 fitted to the U-shaped member 29.

The holder main body 28 includes a base end portion 281 connected to the moving unit 18, and a holder portion 282 that expands in the U-shape from an end of the base end portion 281 and that holds the U-shaped member bar-shaped member (not illustrated) for retaining the both ends of the plate spring 30 is provided on the holder portion 282.

The plate spring 30 comes in contact with the outer periphery of the lower end portion at the U-shape of the U-shaped member 29, and applies a biasing force to the U-shaped member 29. The centering screws 31 as a pair are screwed to the holder portion 282 so as to come into contact with the outer peripheries of the upper end portions of the U-shape of the U-shaped member 29. In this way, the U-shaped member 29 is supported at the three points by the plate spring 30 and the centering screws 31 as a pair.

To assemble the illuminating unit 16 configured as above, the male dovetail 212 of the condenser unit 21 is fitted to and mounted on the female dovetail 291 unit holder 17, and thereafter the side sat screw 32 is screwed to the holder main body 28 to fix the condenser unit 21 to the unit holder 17. Subsequently, the convex part 201 the light source unit 20 is fitted to the concave part 211 of the condenser unit 21, and the light source unit 20 is connected and fixed to the condenser unit 21 by using a fixing screw.

The centering of the condenser unit 21 of the inverted microscope 1 will be explained below. The condenser unit 21 is first mounted on the unit holder 17. Subsequently, the optical element turret 26 is rotated so that the optical element deviates from the optical path of the transmitting illumination light. Thereafter, the field-stop operating unit 25 is operated to appropriately reduce the diameter of the field stop 24, and then the operating unit 19 is rotated to move the unit holder 17. The height of the illuminating unit 16 is adjusted so as to bring the field stop 24 into focus. Subsequently, the field-stop operating unit 25 is operated to adjust focus to the extent that the image of the field stop 24 comes into the field of vision. Thereafter, the centering screws 31 are operated to move the image of the field stop 24 to the center of the field of vision. Then, the field stop 24 is gradually opened so that the image is circumscribed with the field of vision.

In the inverted microscope 1, the light source 22, the field stop 24, and the condenser lens 27 are positioned in advance in an integrated manner. Therefore, it is possible to integrally adjust center positions of the light source unit 20 and the condenser unit 21. Consequently, center misalignment does not occur among the light source 22, the field stop 24, and the condenser lens 27.

According to the first embodiment of the present invention as described above, the illuminating unit includes a light source unit including the light source that generates transmitting illumination light; and the condenser unit, which includes the field stop that can adjust the illumination area of the transmitting illumination light and includes the condenser lens that collects and applies the transmitting illumination light emitted by the light source unit onto the specimen, and which is detachably connected to the light source unit. Therefore, it is possible to integrally adjust focusing and centering of the light source unit, the field stop, and the condenser unit without changing the positional relation of the light source unit, the field stop, and the condenser units that are positioned in advance. Consequently, it is possible to prevent degradation of illumination performance that may occur after the centering of the condenser lens is adjusted.

Furthermore, according to the first embodiment, even if there are a plurality of light source units with optical designs appropriate for respective optical systems, such as the filed stop, a diaphragm, and a lens of the condenser unit, it is not necessary to provide the field stop for each of the light source units. Therefore, it is possible to provide an inverted microscope system at low costs.

Moreover, according to the first, embodiment, because the condenser unit includes the field stop, it is not necessary to provide the field stop for each light source unit.

Furthermore, according to the first embodiment, because the light source is an LED, it is possible to reduce the size of the light source unit.

### Second Embodiment

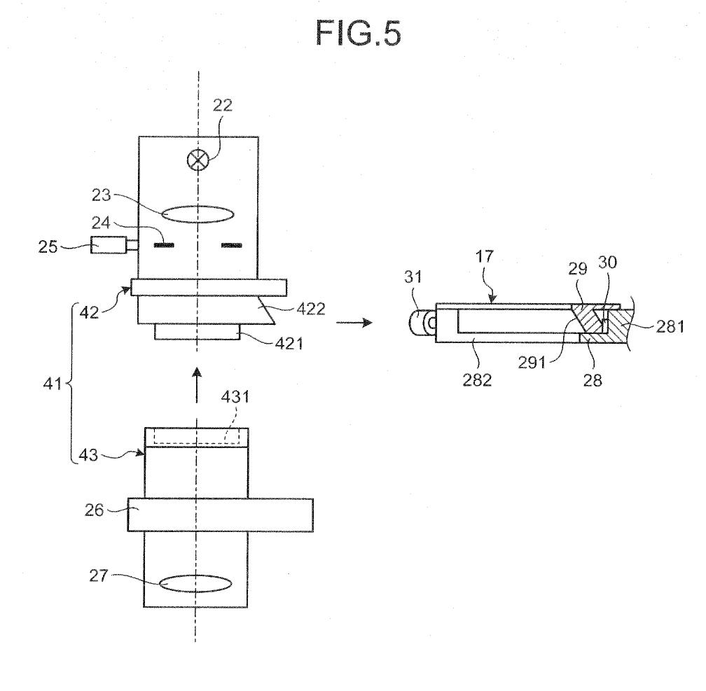

FIG. 5 is a diagram illustrating configurations of an illuminating unit and a unit holder according to a second embodiment of the present invention and an overview of how the illuminating unit is assembled to the unit holder. An illuminating unit 41 illustrated in FIG. 5 includes a light source unit 42 and a condenser unit 43. The illuminating unit 41 is detachably attached to the unit holder 17 of the inverted microscope 1 described above. Therefore, the inverted microscope according to the second embodiment is configured similarly to the inverted microscope 1 by replacing the illuminating unit 16 with the illuminating unit 41.

The light source unit 42 includes the light source 22, the collector lens 23, the field stop 24, and the field-stop operating unit 25. A convex part 421 to be fitted to the condenser unit 43 is formed on a lower end portion of the light source unit 42. A male dovetail 422 in a shape that can be fitted to the female dovetail 291 of the U-shaped member 29 of the unit holder 17 is formed on the upper side of the convex part 421.

The condenser unit 43 includes the optical element turret 26 and the condenser lens 27. A concave part 431 that is to be fitted to and holds the convex part 421 of the light source unit 42 to hold the convex part 421 is formed on an upper end portion of the condenser unit 43.

The positions of the light source unit 42 and the condenser unit 43 in the optical axis direction of the illuminating unit 41 are determined by fitting the convex part 421 and the concave part 431 and by bringing predetermined contact surfaces of the light source unit 42 and the condenser unit 43 into contact with each other. The light source unit 42 and the condenser unit 43 are fixed to each other by a fixing screw (not shown) after the positions are determined.

To assemble the illuminating unit 41 configured as above, the male dovetail 422 of the light source unit 42 is fitted to and mounted on the female dovetail 291 of the unit holder 17, and thereafter the side set screw 32 is screwed to the holder main body 28 to fix the light source unit 42 to the unit holder 17. Subsequently, the concave part 431 of the condenser unit 43 is fitted to the convex part 421 of the light source unit 42, and the condenser unit 43 is connected and fixed to the light source unit 42 by using a fixing screw.

According to the second embodiment of the present invention as described above, the illuminating unit includes the light source unit including the light source that generates transmitting illumination light and a field stop that can adjust the illumination area of the transmitting illumination light; and the condenser unit that includes the condenser lens that collects and applies the transmitting illumination light emitted by light source unit onto the specimen and that is detachably connected to the light source unit. Therefore, it is possible to integrally adjust focusing and centering of the light source unit, the field stop, and the condenser unit without changing the positional relation of the light source unit, the field stop, and the condenser unit that are positioned in advance. Consequently, it is possible to prevent degradation of illumination performance that may occur after the centering of the condenser lens is adjusted.

Furthermore, according to the second embodiment, because the light source unit includes the field stop, it is not necessary to provide the field stop for each condenser unit.

Moreover, according to the second embodiment, even it there are a plurality of condenser units with optical designs appropriate for respective light source units, it is not necessary to provide the field stop for each of the condenser units. Therefore, it is possible to provide an inverted microscope system at low costs.

### Third Embodiment

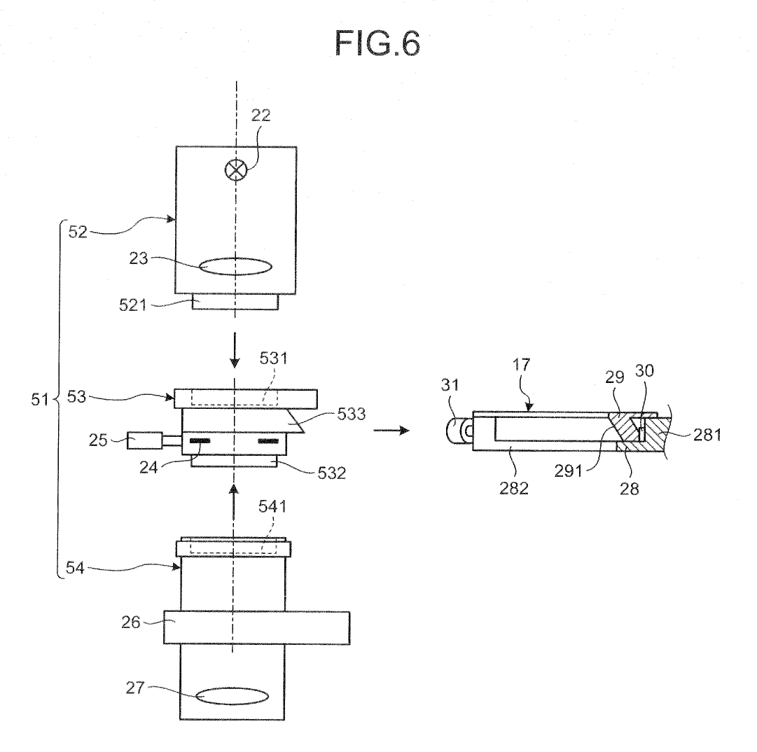

FIG. 6 is a diagram illustrating configurations of an illuminating unit and a unit holder according to a third embodiment of the present invention and an overview of how the illuminating unit is assembled to the unit holder. An illuminating unit 51 illustrated in FIG. 6 includes a light source unit 52, a field stop unit 53, and a condenser unit 54. The illuminating unit 51 is detachably attached to the unit holder 17 of the inverted microscope 1 as described above. Therefore, the inverted microscope according to the third embodiment is configured similarly to the inverted microscope 1 by replacing the illuminating unit 16 with the illuminating unit 51.

The light source unit 52 includes the light source 22 and the collector lens 22 A convex part 521 to be fitted to the field stop unit 53 is formed on a lower end portion of the light source unit 52.

The field stop unit. 53 includes the field stop 24 and the field operating unit 25. A concave part 531 that is be fitted to and holds the convex part 521 of the light source unit 52 is formed on an upper end portion of the field stop unit 53. A convex part 532 to be fitted to the condenser unit 54 is formed on a lower end portion the field stop unit 53. A male dovetail 533 in a shape that can be fitted to the female dovetail 291 of the U-shaped member 29 of the unit holder 17 is formed on the upper side of the convex part 532.

The condenser unit 54 includes the optical element turret 26 and the condenser lens 27. A concave part 541 that is to be fitted to and holds the convex part 532 of the field stop unit 53 is formed on an upper end portion of the condenser unit 54.

The positions of the light source unit 52 and the field stop unit 53 in the optical axis direction of the illuminating unit 51 are determined by fitting the convex part 521 and the concave part 531 and by bringing predetermined contact surfaces of the light source unit 52 an the field stop unit 53 into contact with each other. Similarly, the positions of the field stop unit 53 and the condenser unit 54 in the optical axis direction of the illuminating unit 51 are determined by fitting the convex part 532 and the concave part 541 and by bringing predetermined contact surfaces of the field stop unit 53 and the condenser unit 54 into contact with each other. The light source unit 52 and the field stop unit 53 are fixed to each other by a fixing screw (not shown) after the positions are determined, and the field stop unit 53 and the condenser unit 54 are fixed to each other by a fixing screw (not shown) after the positions are determined.

To assemble the illuminating unit 51 configured as above, the male dovetail 533 of the field stop unit 53 is fitted to and mounted on the female dovetail 291 of the unit holder 17, and thereafter the side set screw 32 is screwed to the holder main body 28 for fixing. Subsequently, the convex part 521 of the light source unit 52 is fitted to and mounted on the concave part 531 of the field stop unit 53, and the light source unit 52 is connected and fixed to the field stop unit 53 by using a fixing screw. Furthermore, the concave part 541 of the condenser unit 54 is fitted to and mounted on the convex part 532 of the field stop unit 53, and the condenser unit 54 is connected and fixed to the field stop unit 53 by using a fixing screw. The light source unit 52 and the condenser unit 54 may be connected to the field stop unit in an arbitrary order.

According to the third embodiment of the present invention as described above, the illuminating unit includes the light source unit including the light source that generates transmitting illumination light; the condenser unit including the condenser lens that collects and applies the transmitting illumination light emitted by the light source unit onto the specimen; and the field stop unit including the field stop, which can adjust the illumination area of the transmitting illumination light, which is located between the light source unit and the condenser unit, and which is detachably connected to the light source unit and the condenser unit. Therefore, it is possible to integrally adjust focusing and centering of the light source unit, the field stop, and the condenser unit without changing the positional relation of the light source unit, the field stop, and the condenser unit that are positioned in advance. Consequently, it is possible to prevent degradation of illumination performance that may occur after the centering of the condenser lens is adjusted.

Furthermore, according to the third embodiment, the field stop is provided in a unit that is independent of the light source and the condenser unit. Therefore, it is possible to use the field stop in combination with various types of light source units and condenser units. Consequently, it is possible to further improve the scalability of the system.

While the embodiments of the present invention are explained above, the present invention is not limited to the first to the third embodiments described above.

For example, in the present invention, the illuminating unit may be configured such that the light source, the field stop, and the condenser lens or integrated.

Furthermore, in the present invention, the position of the male dovetail may be above or below a diaphragm.

Moreover, in the present invention, the male dovetail may be formed on the unit holder and the female dovetail may be formed on the unit side.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept a defined by the appended claims and their equivalents.

What is claimed is:

1. An illuminating unit that is a part of a microscope for forming an image of a specimen being an observation object, that is located above a stage on which the specimen is placed, and that applies transmitting illumination light to the specimen, the illuminating unit comprising:
a light source unit including a light source that generates the transmitting illumination light; and
a condenser unit that includes a condenser lens for collecting and applying the transmitting illumination light emitted by the light source unit onto the specimen, and that is detachably connected to the light source unit.

2. The illuminating unit according to claim 1, wherein the condenser unit includes a field stop located closer to a connected position of the condenser unit and the light source unit than the condenser lens.

3. The illuminating unit according to claim 1, wherein the light source unit includes a field stop located closer to a connected position of the condenser unit and the light source unit than the light source.

4. The illuminating unit according to claim 1, further comprising a field stop unit that is located between the light source unit and the condenser unit so as to be detachably connected to the light source unit and the condenser unit, and that includes a field stop.

5. The illuminating unit according to claim 1, wherein the light source is a light emitting diode.

6. An inverted microscope comprising:
an illuminating unit that is a part of the inverted microscope for forming an image of a specimen being an observation object, that is located above a stage on which the specimen is placed, and that applies transmitting illumination light to the specimen, the illuminating unit comprising:
a light source unit including a light source that generates the transmitting illumination light; and
a condenser unit that includes a condenser lens for collecting and applying the transmitting illumination light emitted by the light source unit onto the specimen, and that is detachably connected to the light source unit; and
a unit holder that detachably holds the illuminating unit and that is movable up and down relative to the specimen.

7. The inverted microscope according to claim 6, wherein the unit holder detachably holds the light source unit.

8. The inverted microscope according to claim 6, wherein the unit holder detachably holds the condenser unit.

9. An inverted microscope comprising:
an illuminating unit that is a part of the inverted microscope for forming an image of a specimen being an observation object, that is located above a stage on which the specimen is placed, and that applies transmitting illumination light to the specimen, the illuminating unit comprising:
a light source unit including a light source that generates the transmitting illumination light;
a condenser unit that includes a condenser lens for collecting and applying the transmitting illumination light emitted by the light source unit onto the specimen, and that is detachably connected to the light source unit; and
a field stop unit that is located between the light source unit and the condenser unit so as to he detachably connected to the light source unit and the condenser unit, and that includes a field stop; and
a unit holder that is movable up and down relative to the specimen and that detachably holds the field stop unit.
